(19) United States
(12) Patent Application Publication
(10) Pub. No.: US 2026/0211641 A1
(43) Pub. Date: Jul. 23, 2026

(54) METHOD AND APPARATUS FOR GENERATING CODES BASED ON ARTIFICIAL INTELLIGENCE (AI), AND ELECTRONIC DEVICE

(71) Applicant: BEIJING BAIDU NETCOM SCIENCE TECHNOLOGY CO., LTD., Beijing (CN)

(72) Inventors: Zengle Ge, Beijing (CN); Haobo Zhang, Beijing (CN); Annan Li, Beijing (CN); Jianmin Wu, Beijing (CN); Dou Shen, Beijing (CN)

(73) Assignee: BEIJING BAIDU NETCOM SCIENCE TECHNOLOGY CO., LTD., Beijing (CN)

(21) Appl. No.: 19/568,674

(22) Filed: Mar. 16, 2026

(30) Foreign Application Priority Data
Sep. 24, 2025 (CN) 202511376838.5

(51) Int. Cl. G06F 8/35; G06F 8/33; G06F 40/205

(52) U.S. Cl. CPC G06F 8/35; G06F 8/33; G06F 40/205

(57) ABSTRACT

A method for generating codes based on artificial intelligence (AI) includes: obtaining block text data of a multimedia text and a problem text to be processed, in which the block text data includes a plurality of block texts and block information of each block text, and the block information includes formula information; selecting target block texts from the plurality of block texts based on the plurality of block texts, the formula information in each block information and the problem text; and performing code generation processing based on the target block texts, block information of the target block texts and the problem text.

### CROSS-REFERENCE TO RELATED APPLICATION

This application claims priority to and benefits of Chinese Patent Application Serial No. 2025113768385 filed the State Intellectual Property Office of P. R. China on Sep. 24, 2025, the entire content of which is incorporated herein by reference.

### TECHNICAL FIELD

The disclosure relates to a field of artificial intelligence (AI) technologies, and particularly to a technical field such as deep learning, cloud computing, natural language processing, big models, intelligent agents, coding agents, and assisted programming, and more particularly to a method and an apparatus for generating codes based on AI, and an electronic device.

### BACKGROUND

Presently, for a research thesis, parsing processing may be performed on the research thesis to obtain a paragraph-level text, in which the paragraph-level text may include multiple natural paragraphs, etc. Thesis understanding processing is performed based on the paragraph-level text.

In the above solution, a solution for generating codes based on the research thesis is not involved.

### SUMMARY

According to a first of the disclosure, a method for generating codes based on AI is provided, including: obtaining block text data of a multimedia text and a problem text to be processed, in which the block text data includes a plurality of block texts and block information of each block text, and the block information includes formula information; selecting target block texts from the plurality of block texts based on the plurality of block texts, formula information in each block information and the problem text; and performing code generation processing based on the target block texts, block information of the target block texts and the problem text.

According to a second aspect of the disclosure, an electronic device is provided, including: at least one processor; and a memory communicatively coupled to the at least one processor, in which the memory stores instructions executable by the at least one processor that, when executed by the at least one processor, the at least one processor is caused to execute the method for generating codes based on AI provided above in the first aspect of the disclosure.

According to a third aspect of the disclosure, a non-transitory computer-readable storage medium for storing computer instructions is provided. The computer instructions are configured to enable a computer to execute the method for generating codes based on AI provided above in the first aspect of the disclosure.

### BRIEF DESCRIPTION OF THE DRAWINGS

The accompanying drawings are used for a better understanding of the disclosure and do not constitute a limitation of the disclosure.

FIG. 1 is a flow chart illustrating a method for generating codes based on artificial intelligence (AI) according to a first embodiment of the disclosure.

FIG. 2 is a flow chart illustrating a method for generating codes based on AI according to a second embodiment of the disclosure.

FIG. 3 is a flow chart illustrating a method for generating codes based on AI according to a third embodiment of the disclosure.

FIG. 4 is a flow chart illustrating a method for generating codes based on AI according to a fourth embodiment of the disclosure.

FIG. 5 is a block diagram illustrating an apparatus for generating codes based on AI according to a fifth embodiment of the disclosure.

FIG. 6 is a block diagram illustrating an agent according to a sixth embodiment of the disclosure.

FIG. 7 is a block diagram illustrating an electronic device for realizing a method for generating codes based on artificial intelligence (AI) according to embodiments of the disclosure.

### DETAILED DESCRIPTION

Exemplary embodiments of the disclosure are described hereinafter in combination with the accompanying drawings, which include various details of embodiments of the disclosure in order to aid in understanding, and should be considered exemplary only. Accordingly, the skilled in the art should recognize that various changes and modifications may be made to embodiments described herein without departing from the scope and spirit of the disclosure. Similarly, descriptions of well-known features and structures are omitted from the following description for the sake of clarity and brevity.

Currently, for a research V, parsing processing may be performed on the research thesis to obtain a paragraph-level text, in which the paragraph-level text may include multiple natural paragraphs, etc. Thesis understanding processing is performed based on the paragraph-level text.

In the above solution, a solution for generating codes based on the research thesis is not involved.

For the above problem, the disclosure provides a method and an apparatus for generating codes based on artificial intelligence (AI), and an electronic device.

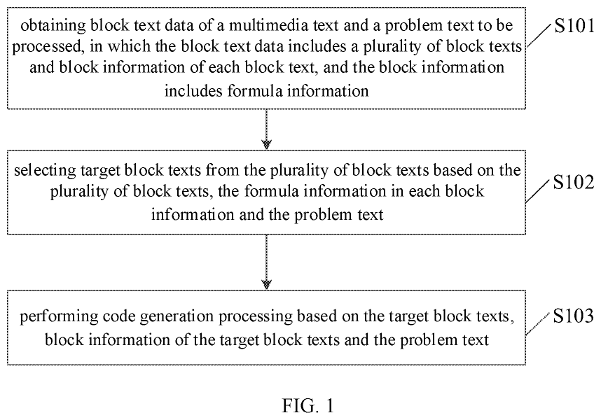

FIG. 1 is a flow chart according to a first embodiment of the disclosure. It needs to be noted that a method for generating codes based on AI in embodiments of the disclosure may be applied to an apparatus for generating codes based on AI, and the apparatus may be configured in an electronic device, such that the electronic device may perform code generating function based on AI.

The electronic device may be any device having a computing capability, which may be, such as, a personal computer (PC), a mobile terminal, a server, etc. The mobile terminal may be, such as, a hardware device having various operating systems, touch screens, and/or displays, such as a vehicle-mounted device, a telephone, a tablet, a personal digital assistant, a wearable device, a smart speaker, a server, a server cluster, etc.

The apparatus for generating codes based on AI may also be software in the electronic device, such as software for generating codes based on AI, etc. In following embodiments, description is made by taking an execution subject being an electronic device as an example.

As illustrated in FIG. 1, the method for generating codes based on AI may include following.

At block S101, block text data of a multimedia text and a problem text to be processed are obtained, in which the block text data includes a plurality of block texts and block information of each block text, and the block information includes formula information.

The multimedia text may include a material such as a thesis, an academic article, a research report, etc.; the block text of the multimedia text may be obtained by segmenting the multimedia text based on a set text length; and the block information of the block text may include the formula information and description information of the block text, and the description information may refer to abstract information of the block text.

The problem text to be processed may refer to a text obtained by performing text conversion processing on a query input by a user via a speech, a text, etc. on an interactive interface, in which the query is used to request code generation based on the multimedia text.

For example, the problem text to be processed may be “please summarize algorithm steps”, “explain a derivation process of equation (3)”, “please output codes corresponding to equations (1) to (5)”, etc.

At block S102, target block texts are selected from the block texts based on the plurality of block texts, the formula information in each block information and the problem text.

The electronic device may select the target block texts associated with the problem text from the plurality of block texts based on the plurality of block texts and the formula information in each block information.

For example, in a case that the problem text includes a specified formula, target block texts including the specified formula may be selected from the plurality of block texts based on the formula information in each block information.

In embodiments of the disclosure, before block S102, the electronic device may also perform: extracting range-related information from the problem text; determining, based on the range-related information, a first block text in the block text data that matches the range-related information; and screened out other block texts in the block text data than the first block text.

The range-related information is used to indicate a boundary and a limiting condition involved in the code generation. For example, the range-related information may include a page number range, a chapter range, a formula range, etc.

After determining the first block text in the block text data that matches the range-related information, the target block texts may be selected from the first block text based on the plurality of block texts, the formula information in each block information, and the problem text.

By extracting the range-related information in the problem text, a relevant block text may be accurately positioned, the first block text may be quickly screened out, and other irrelevant block texts may be screened out, thus improving the information retrieval efficiency, reducing the processing of irrelevant data, and ensuring that a subsequent analysis focuses on a text block within a specified range.

At block S103, code generation processing is performed based on the target block texts, block information of the target block texts and the problem text.

The target block texts, the block information of the target block texts and the problem text may be used as an input of a big model or an agent, such that the big model or the agent performs the code generation processing based on input information. It needs to be noted that the user may conduct a plurality of rounds of conversations with the big model or the agent. In this case, the target block texts may be selected based on range-related information in content of the plurality of rounds of conversations, which ensures the coherence and accuracy of the plurality of rounds of conversations.

With the method for generating codes based on AI in embodiments of the disclosure, the block text data of the multimedia text and the problem text to be processed are obtained, in which the block text data includes the plurality of block texts and the block information of each block text, and the block information includes the formula information; the target block texts are selected from the plurality of block texts based on the plurality of block texts, the formula information in the block information and the problem text; and the code generation processing is performed based on the target block texts, the block information of the target block texts and the problem text. A formula is an important manifestation of a mathematical logic of an algorithm. Selecting the target block texts from the plurality of block texts in combination with the formula information may ensure that code generation strictly follows a mathematical logic in the multimedia text, which improves the accuracy and logical consistency of the code generation.

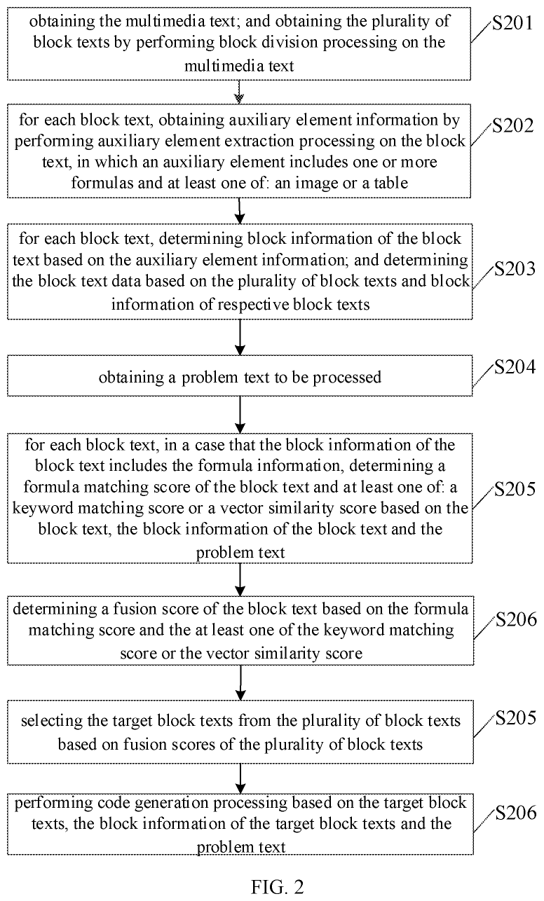

In order to further improve the accuracy of the code generation, the electronic device may obtain auxiliary element information by performing auxiliary element extraction processing on each block text, thus obtaining block information of the block text; and selecting the target block texts from the plurality of block texts based on fusion scores of the plurality of block texts. As illustrated in FIG. 2, FIG. 2 is a flow chart according to a second embodiment of the disclosure. Embodiments illustrated in FIG. 2 may include THE following.

At block S201, the multimedia text is obtained; and the plurality of block texts are obtained by performing block division processing on the multimedia text.

The block text obtained may include at least one natural paragraph, and at least one block text includes at least one of a formula, an image, or a table.

At block S202, for each block text, auxiliary element information is obtained by performing auxiliary element extraction processing on the block text, in which an auxiliary element includes one or more formulas and at least one of: an image or a table.

In embodiments of the disclosure, a process of performing block S202 by the electronic device may be, for example, obtaining the auxiliary element and/or an auxiliary element sequence number in the block text by performing the auxiliary element extraction processing and auxiliary element sequence number extraction processing on the block text; determining an auxiliary element bound to the auxiliary element sequence number; and determining the auxiliary element information based on the auxiliary element in the block text and/or the auxiliary element bound to the auxiliary element sequence number.

The auxiliary element corresponds to the auxiliary element sequence number. For example, a formula has a formula sequence number, an image has an image sequence number, and a table has a table sequence number. The auxiliary element information may include description information of the auxiliary element.

For example, auxiliary element information corresponding to the formula may include the formula, a meaning of each parameter in the formula, and a function of the formula, etc.; auxiliary element information corresponding to the image may include a description text of the image; and auxiliary element information corresponding to information table may include a description text of the table.

The block text may include the auxiliary element and the auxiliary element sequence number, or may only include the auxiliary element sequence number. For example, a current block text refer an auxiliary element in other block texts in a reference way, but does not directly include the auxiliary element.

The auxiliary element bounding to the auxiliary element sequence number may be located in a current block text or may be located in other block texts.

By extracting the auxiliary element from the block text, or positioning the auxiliary element associated with the block text via the auxiliary element sequence number in the block text, the auxiliary element associated with the block text may be captured comprehensively and accurately, thus obtaining comprehensive and complete auxiliary element information.

In embodiments of the disclosure, in an example, the auxiliary element includes the one or more formulas, the auxiliary element sequence number includes a formula sequence number, and a process of obtaining the information of the auxiliary element of the formula by the electronic device may be, for example, obtaining a processed formula by performing aggregation processing on the one or more formulas in the block text based on the formula sequence number; and determining formula information in the auxiliary element information based on the processed formula and/or a formula bound to the formula sequence number.

The formula bound to the formula sequence number may be located in a current block text or may be located in other block texts.

An explicit formula (a formula occupying a single line), an inline formula (a formula embedded in a line of a main text), a mathematical expression, and other types of formulas in the block text may be extracted in a regular expression and a heuristic manner.

The formula information may include the processed formula, a corresponding formula sequence number and a meaning of a parameter in the formula, and/or, the formula bound to the formula sequence number, a corresponding formula sequence number and a meaning of a parameter in the formula. It needs to be noted that, for the obtained formula, parameter-meaning may be extracted from a context of the formula and aligned with a main text to form a dictionary.

By aggregating the one or more formulas in the block text based on the formula sequence number, scattered formula information may be effectively integrated, which avoids formula fragmentation. Determining the formula information in combination with the aggregated formula and/or the formula bound to the sequence number may structure the formula into queryable data, enrich basis information for the code generation, and ensure the completeness and accuracy of the formula information.

In embodiments of the disclosure, in an example, the auxiliary element includes the image and/or the table, the auxiliary element sequence number includes an image sequence number and/or a table sequence number, and a process of obtaining the auxiliary element information of the image and/or table by the electronic device may be, for example, determining image information in the auxiliary element information based on a description text of the image in the block text and/or a description text of an image bound to the image sequence number; and/or, determining table information in the auxiliary element information based on a description text of the table in the block text and/or a description text of a table bound to the table sequence number.

The description text of the image may be obtained by summarizing image content. For example, the description text of the image may be an abstract of the image content; and the description text of the table may be obtained by summarizing table content. For example, the description text of the table may be an abstract of the table content.

For the image and the table, by using the description text of the image and the description text of the table within the block text, and the description text of the image bound to the image sequence number and the description text of the table bound to the table sequence number, the image and the table may be structured into the queryable data, which enriches the basis information for the code generation, thus improving the accuracy of the code generation.

At block S203, for each block text, block information of the block text is determined based on the auxiliary element information; and the block text data is determined based on the plurality of block texts and the block information of respective block texts.

The block information includes the auxiliary element information of the block text and a block text number, etc.; and the block text data includes the plurality of block texts and the block information corresponding to each block text.

At block S204, a problem text to be processed is obtained.

The multimedia text uploaded by a user may be processed based on blocks S201 to S203 first, and then a query input by the user may be obtained and processed to obtain the problem text.

At block S205, for each block text, in a case that the block information of the block text includes the formula information, a formula matching score of the block text and at least one of: a keyword matching score or a vector similarity score are determined based on the block text, the block information of the block text and the problem text.

The formula matching score indicates a matching degree between the formula information corresponding to the block text and the formula information in the problem text; the keyword matching score indicates a matching degree between a keyword in the problem text and a keyword in the block text; and the vector similarity score indicates a similarity degree between a text vector of the problem text and a text vector of the block text.

In embodiments of the disclosure, in an example, a process of determining the keyword matching score of the block text by the electronic device may be, for example, obtaining first keywords in the problem text by performing keyword extraction processing on the problem text; determining second keywords in the first keywords, in which the second keyword is a keyword included in the block text and/or the block information of the block text; and determining the keyword matching score based on a number of second keywords and a number of first keywords.

The second keyword may refer to a keyword that is included in the problem text, and the block text and/or the block information of the block text.

For example, the keyword matching score may be determined based on a ratio of the number of second keywords to the number of first keywords. The larger the number of second keywords is, the higher the keyword matching score is; and the smaller the number of second keywords is, the lower the keyword matching score is.

Calculating the keyword matching score based on the number of first keywords and the number of second keywords may not only accurately measure a matching association degree between the problem text and the block text, but also quantify the matching degree between keywords, thus providing an objective basis for screening the target block text.

In embodiments of the disclosure, in an example, a process of determining the vector similarity score of the block text by the electronic device may be, for example, determining a first vector of the block text and a second vector of the problem text; determining a vector similarity between the first vector and the second vector; and determining the vector similarity as the vector similarity score.

The first vector and the second vector may be text semantic vectors; and the vector similarity may refer to a cosine similarity between the first vector and the second vector.

By converting the block text and the problem text into vectors and calculating a similarity between the first vector and the second vector, a semantic association degree between the block text and the problem text may be accurately quantified mathematically, and an accurate vector similarity score may be obtained.

In embodiments of the disclosure, in an example, a process of determining the formula matching score of the block text by the electronic device may be, for example, determining formula information of the problem text; determining at least one of: a formula sequence number matching score, a formula structure matching score or a formula variable matching score based on the formula information of the block text and the formula information of the problem text; and determining the formula matching score based on the at least one of the formula sequence number matching score, the formula structure matching score or the formula variable matching score.

The formula sequence number matching score indicates a matching degree between a formula sequence number associated with the problem text and a formula sequence number associated with the block text; the formula structure matching score indicates a matching degree between a structure of the formula associated with the problem text and a structure of the formula associated with the block text; and the formula variable matching score indicates a matching degree between a variable in the formula associated with the problem text and a variable in the formula associated with the block text.

For example, the electronic device may calculate the formula sequence number matching score by:

$${S}_{eqno} ( d , q ) = 1 \{ eqno ( q ) = eqno ( d ) \} ,$$

where S_{eqno}(d, q) represents the formula sequence number matching score, eqno(q) represents a formula sequence number associated with a problem text q, and eqno(d) represents the formula sequence number associated with a block text d. In a case that the formula sequence number associated with the problem text is the same as the formula sequence number associated with the block text, S_{eqno}(d, q) is 1; and in a case that the formula sequence number associated with the problem text is different from the formula sequence number associated with the block text, S_{eqno}(d, q) is 0.

For example, the electronic device may calculate the formula structure matching score by:

$${S}_{subexpr} ( d , q ) = exp ( - \frac{TED ( {T}_{q} , {T}_{d} )}{Z} )$$

$$TED ( {T}_{q} , {T}_{d} ) = {min}_{edit seq} {\sum }_{i} ω ( {op}_{i} ) ,$$

where S_{subexpr}(d, q) represents the formula structure matching score, TED(T_{q}, T_{d}) represents a weighted tree edit distance between two operator trees T_{q} and T_{d}, T_{q} represents an operator tree obtained by parsing the formula associated with the problem text, and T_{d} represents an operator tree obtained by parsing the formula associated with the block text; Z represents a normalization constant, and may be an average tree size or a maximum tree depth; edit seq represents an edit sequence, which refers to a series of edit operations required to transform the tree T_{q} into the tree T_{d}; and ω(opᵢ) represents a weight corresponding to the i-th edit operation opᵢ in the edit sequence.

In a case that the structure of the formula associated with the problem text is completely consistent with the structure of the formula associated with the block text, TED(T_{q}, T_{d})=0, and S_{subexpr}(d, q)=1; and in a case that the structure of the formula associated with the problem text differs greatly from the structure of the formula associated with the block text, TED(T_{q}, T_{d}) increases, and S_{subexpr}(d, q) decays.

For example, the electronic device may calculate the formula variable matching score by:

$${S}_{var} ( d , q ) = \frac{\vert ∅ ( {V}_{q} ) ⋂ {V}_{d} \vert}{\vert {V}_{q} \vert} ,$$

where Sᵥₐᵣ(d, q) represents the formula variable matching score, V_{q} represents a set of variables of the formula associated with the problem text, V_{d} represents a set of variables of the formula associated with the block text, |Ø(V_{q})∩V_{d}| represents a number of variables in an intersection of V_{q} and V_{d}, and |V_{q}| represents a number of variables in a variable set of the formula associated with the problem text.

For example, the electronic device may calculate the formula matching score by:

$$M ( d , q ) = {λ}_{1} {S}_{eqno} ( d , q ) + {λ}_{2} {S}_{subexpr} ( d , q ) + {λ}_{3} {S}_{var} ( d , q ) ,$$

where M(d, q) represents the formula matching score, and λ₁, λ₂, and λ₃ are weights corresponding to the formula sequence number matching score, the formula structure matching score, and the formula variable matching score, respectively. As an example, λ₁=0.3, λ₂=0.3, λ₃=0.4.

By extracting the formula information of the problem text and the formula information of the formula information of the block text, and respectively calculating the matching scores in terms of formula sequence number, structure, and variable, a formula matching degree may be accurately measured in a plurality of dimensions. By determining the formula matching score in combination the scores, the matching degree between the formula in the problem text and the formula in the block text may be evaluated comprehensively and carefully.

At block S206, a fusion score of the block text is determined based on the formula matching score and the at least one of the keyword matching score or the vector similarity score.

The fusion score of the block text may be determined based on any one or more of the keyword matching score and the vector similarity score.

For example, the electronic device may calculate the fusion score of the block text by:

$$score ( d , q ) = α \cdot BM 25 ( d , q ) + β \cdot cos ( e ( d ) , e ( q ) ) + γ \cdot M ( d , q ) ,$$

where score(d, q) represents the fusion score, BM25(d, q) represents the keyword matching score, cos(e(d), e(q)) represents the vector similarity score, e(d) represents the first vector, e(q) represents a the second vector, and M(d, q) represents the formula matching score.

It needs to be noted that in a case that the block information of the block text does not include the formula information, the keyword matching score and/or the vector similarity score may be determined, and the fusion score of the block text is determined based on the keyword matching score and/or the vector similarity score.

At block S207, the target block texts are selected from the plurality of block texts based on fusion scores of the plurality of block texts.

In embodiments of the disclosure, for example, the plurality of block texts may be sorted in a descending order based on the fusion scores of respective block texts, and first K block texts are selected from the plurality of sorted block texts as the target block texts.

In another example, a process of performing block S207 by the electronic device may be, for example, selecting a plurality of candidate block texts from the plurality of block texts based on the fusion scores of the plurality of block texts; obtaining a candidate block text combination by combining at least one candidate block text in the plurality of candidate block texts; determining whether the candidate block text combination satisfies a restricted condition based on a fusion score, a block text weight and a length weight of each candidate block text in the candidate block text combination; in a case that the candidate block text combination satisfies the restricted condition, determining the candidate block text in the candidate block text combination as the target block text; and in a case that the candidate block text combination does not satisfy the restricted condition, re-obtaining a candidate block text combination until an obtained candidate block text combination satisfies the restricted condition.

The plurality of block texts may be sorted in a descending order based on the fusion scores of respective block texts, and first K block texts in the plurality of sorted block texts are selected as candidate block texts.

For any candidate block text, a block text weight w(d) may be calculated based on the fusion score, the block text weight, and the length weight of the candidate block text; and it is determined whether the candidate block text combination satisfies a restriction condition based on the block text weight of each candidate block text in the candidate block text combination. It needs to be noted that the block text weight may be determined based on a chapter where the block text is located, and the length weight is determined based on a length of the block text.

The restriction condition may refer to a length cost restriction condition. For example, the process of obtaining the candidate block text combination satisfying the restriction condition may be represented by:

$${max}_{S ⊆ D} {\sum }_{d ∈ S} w ( d ) s . t . {\sum }_{d ∈ S} c ( d ) \leq B ,$$

where w(d) represents a block text weight corresponding to the d-th candidate block text in the candidate block text combination, S represents the candidate block text combination, D represents a combination formed by the plurality of candidate block texts selected from the plurality of block texts, c(d) represents a text length corresponding to the d-th candidate block text in the candidate block text combination, and B represents a set text length budget.

A heuristic “greedy+diversity” may be employed to determine the candidate block text combination that satisfies the restriction condition.

It needs to be noted that the block text weight may also be determined based on the fusion score, the block text weight, the length weight of the candidate block text, and a corresponding diversity score, such that the target block text maintains a coverage breadth and criticality within a limited budget. The diversity score may include a chapter diversity score and/or a page diversity score.

By screening the candidate block text based on the fusion score and obtaining the candidate block text combination by combining the block texts, and by comprehensively considering the fusion score, the block text weight, and the length weight, to determine whether the candidate block text combination satisfies the restriction condition, a target block text that is associated with the problem text and meets the restriction condition may be accurately screened out.

At block S208, code generation processing is performed based on the target block texts, the block information of the target block texts and the problem text.

It needs to be noted that, for detailed content of blocks S204 and S208, please refer to blocks S101 and S103 in the embodiments illustrated in FIG. 1, which is not described in detail here.

With the method for generating codes based on AI in the embodiments of the disclosure, the multimedia text is obtained; the plurality of block texts are obtained by performing the block division processing on the multimedia text; for the each block text, the auxiliary element information is obtained by performing the auxiliary element extraction processing on the block text, in which the auxiliary element includes the one or more formulas and the at least one of: the image or the table; for the each block text, the block information of the block text is determined based on the auxiliary element information; the block text data is determined based on the plurality of block texts and the block information of the plurality of block texts; the problem text to be processed is obtained; for the each block text, in the case that the block information of the block text includes the formula information, the formula matching score of the block text, and the at least one of: the keyword matching score or the vector similarity score are determined based on the block text, the block information of the block text and the problem text; the fusion score of the block text is determined based on the formula matching score and the at least one of the keyword matching score or the vector similarity score; the target block texts are selected from the plurality of block texts based on the fusion scores of the plurality of block texts; and the code generation processing is performed based on the target block texts, the block information of the target block texts and the problem text. Performing the block division processing on the multimedia text may realize disassembly of the multimedia text. Performing the auxiliary element extraction on the block text may construct comprehensive and structured block text data based on information such as the formula, the image, and the table, which provides a basis for subsequent selection of the target block texts. In combination with the problem text, the fusion scores of the plurality of block texts are calculated from a plurality of dimensions, and the target block text is screened out accordingly, which may screen out the target block text that matches the problem text, thus improving the accuracy of the code generation and making generated codes more suitable for user's requirement.

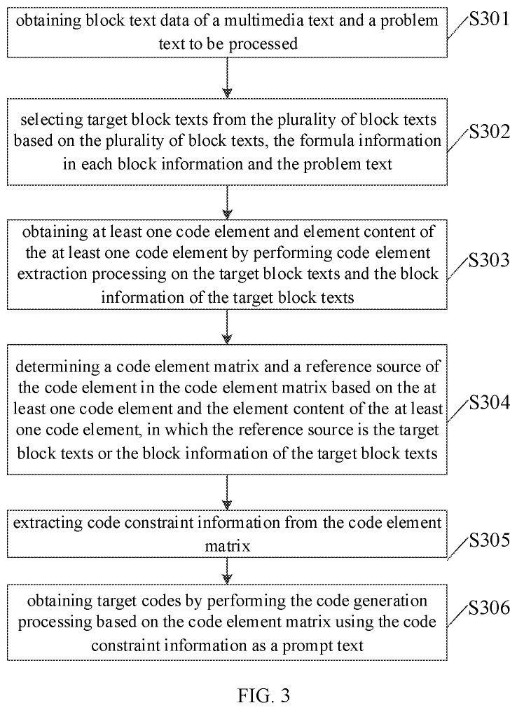

In order to further improve standardization and accuracy of the code generation, a code element matrix may be determined based on the target block texts and the block information of the target block texts, which accurately sorts out key information of the code generation; and code constraint information is extracted from the code element matrix, and the code generation processing is performed based on the code constraint information and the code element matrix, thus improving standardization and accuracy of the code generation. As illustrated in FIG. 3, FIG. 3 is a flow chart according to a third embodiment of the disclosure, and embodiments illustrated in FIG. 3 may include the following.

At block S301, block text data of a multimedia text and a problem text to be processed are obtained.

At block S302, target block texts are selected from a plurality of block texts based on the plurality of block texts, formula information in each block information and the problem text.

At block S303, at least one code element and element content of the at least one code element are obtained by performing code element extraction processing on the target block texts and block information of the target block texts.

The code element refers to a technical point required for generating target codes. For example, the code element includes a problem and a motivation, an algorithm step, a formula definition, a key hyperparameter, etc.

The at least one code element and the element content of the at least one code element may be obtained by performing a mapping to reducing process on the target block texts and the block information of the target block texts.

In embodiments of the disclosure, a process of performing block S303 by the electronic device may be, for example, obtaining abstract content corresponding to each target block text by performing abstract extraction processing on the target block text and the block information of the target block text; obtaining summarized abstract content by performing summarization processing on abstract contents corresponding to respective target block texts; and obtaining the at least one code element and the element content of the at least one code element by performing the code element extraction processing on the summarized abstract content.

A big model is employed to perform abstract extraction processing on the target block text and the block information of the target block text, perform the summarization processing on the abstract contents corresponding to the respective target block texts, and perform the code element extraction processing on the summarized abstract content.

An abstract is extracted from the target block text and the block information first, then the abstract contents corresponding to respective target block texts are summarized, and finally the code element is extracted from the summarized abstract content, thus avoiding directly processing a large amount of original texts, greatly reducing a data processing amount, reducing computational complexity, and improving efficiency of code element extraction.

At block S304, a code element matrix and a reference source of the code element in the code element matrix are determined based on the at least one code element and the element content of the at least one code element, in which the reference source is the target block texts or the block information of the target block texts.

The code element matrix may be generated based on the code element and corresponding element content. It needs to be noted that the reference source of the code element may also be included in the code element matrix. For example, the reference source may be a block text identifier or a block information identifier.

The code element matrix may further include a confidence level of the reference source, in which the confidence level is determined based on the fusion score of the block text.

At block S305, code constraint information is extracted from the code element matrix.

The code constraint information is used to limit a freedom degree of the model and avoid implementation details in the codes that are inconsistent with the multimedia text. For example, the code constraint information includes an input type, an input shape (a dimension constraint of the input data), an output type, an output shape (a dimension constraint of the output data), a variable domain and unit, an exception condition, a precondition and postcondition, etc.

In embodiments of the disclosure, before block S305, the electronic device may also perform a following process: determining whether there is a missing code element not configured with element content in the code element matrix; in a case that there is the missing code element in the code element matrix, determining a reference knowledge text corresponding to the problem text; performing extraction processing on element content of the missing code element based on the reference knowledge text; and performing update processing on the code element matrix based on the element content of the missing code element.

The presence of the missing code element in the code element matrix may indicate that the multimedia text does not explain the code element, and the code element matrix obtained at this time is insufficient to generate complete codes.

The reference knowledge text may refer to a knowledge text retrieved from other multimedia texts or other databases.

Abstract content corresponding to the reference knowledge text may be obtained by performing the abstract extraction processing on the reference knowledge text; and the extraction processing of the element content of the missing code element may be performed on the abstract content corresponding to the reference knowledge text.

It is checked whether there is a missing content in the code element matrix, which helps to discover a data incompleteness issue timely before the code generation; and the reference knowledge text corresponding to the problem text is determined to extract missing element content and update the matrix, which may supplement and improve the code element matrix by combining external information, and then perform the code generation based on an updated code element matrix, thus improving the completeness of the code generation.

At block S306, target codes are obtained by performing the code generation processing based on the code element matrix using the code constraint information as a prompt text.

The prompt text may also include information such as a constraint temperature of the big model, an explicit dependency (e.g., code database restriction), and an output directory structure template and a function comment template.

In embodiments of the disclosure, after block S306, the electronic device may further perform: generating test codes corresponding to the target codes based on the target codes; obtaining a test result by performing test processing on the target codes based on the test code; in a case that the test result indicates existence of an abnormal code segment in the target codes, determining a target code element in the code element matrix related to the abnormal code segment; and performing adjustment processing on the target codes based on a reference source of the target code element, until there is no abnormal code segment in adjusted target codes.

The test code may be used for unit test/property test, such as non-negativity of a loss function, monotonicity within a parameter domain, a numerical stability check, etc., and may also be used for shape, type, boundary sample checking, and static analysis rule scoring.

A re-retrieval of code element content may be performed based on the reference source of the target code element, and the adjustment processing is performed on the target codes based on re-retrieved code element content.

Using the test code, an automatic test of the target code and precise positioning of a problematic code segment may be achieved; by performing the adjustment processing on the target codes based on the target code element related to the abnormal code segment, an automatic repair loop of the abnormal codes may be realized, which reduces manual troubleshooting cost and improves a code generation quality.

In embodiments of the disclosure, a process for performing, by the electronic device, the adjustment processing on the target codes based on the reference source of the target code element may be, for example: determining a first target block text or first block information related to the abnormal code segment based on the reference source of the target code element; determining an adjustment strategy of the abnormal code segment based on the first target block text or the first block information; and obtaining adjusted target codes by performing the adjustment processing on the abnormal code segment in the target codes based on the adjustment strategy.

Targeted retrieval may be performed based on the reference source of the target code element, for example, retrieval may be performed based on a formula sequence number, a formula variable, and a chapter neighborhood. In addition, the adjustment strategy may be generated based on a minimum difference patch strategy to avoid a new error caused by large-scale rewriting.

A root cause of an anomaly is directly associated with an original basis for the code generation. Therefore, compared with blind repair, the root cause of the anomaly (the first target block text or the first block information) is accurately positioned via the reference source of the target code element, and the adjustment strategy is determined in combination with the root cause of the anomaly, which may avoid introducing a new problem and make the repair more precise and thorough, thus improving a fixing effect.

It needs to be noted that, for detailed content of blocks S301 to S302, please refer to blocks S101 to S102 in the embodiments illustrated in FIG. 1, which is described in detail here.

With the method for generating codes based on AI in the embodiments of the disclosure, the block text data of the multimedia text and the problem text to be processed are obtained; the target block texts are selected from the plurality of block texts based on the plurality of block texts, the formula information in the block information and the problem text; the at least one code element and the element content of the at least one code element are obtained by performing the code element extraction processing on the target block texts and the block information of the target block texts; the code element matrix and the reference source of the code element in the code element matrix are determined based on the at least one code element and the element content of the at least one code element, in which the reference source is the target block texts or the block information of the target block texts; the code constraint information is extracted from the code element matrix; and the target codes are obtained by performing the code generation processing based on the code element matrix using the code constraint information as the prompt text. By extraction of the code element and construction of the matrix, key points of the algorithm in the multimedia text may be systematically integrated, which improves the standardization and accuracy of the code generation; the reference source of the code element enables backtracking of a basis for the code generation. Constraint information is extracted from the code element matrix, thus guiding generated codes, and improving the consistency between the generated codes and the algorithm in the multimedia text.

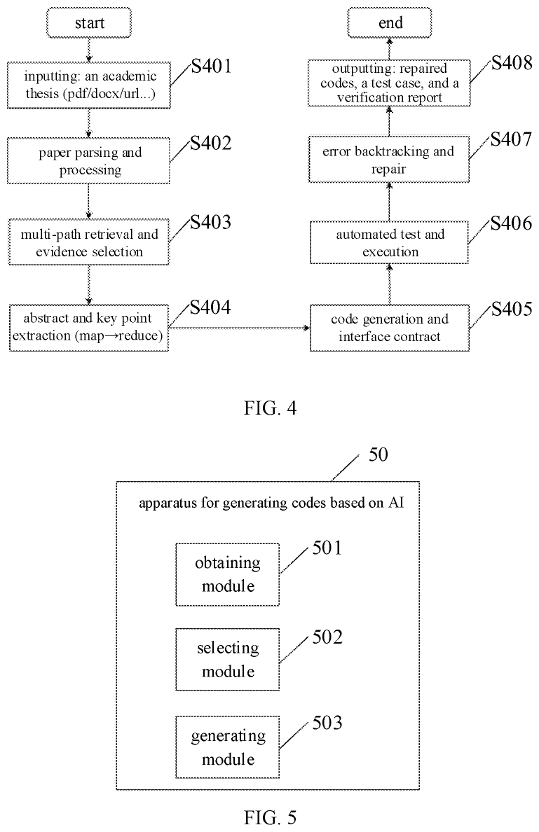

FIG. 4 is a block diagram according to a fourth embodiment of the disclosure. FIG. 4 is a framework schematic diagram of multimedia text processing. The disclosure may be applied to a scenario “from a research thesis to executable codes”. The following description takes the multimedia text being an academic thesis as an example. In detail, following steps may be included. At block S401, inputting an academic thesis, or inputting a uniform resource locator (URL) of an academic thesis, in which a format of the academic thesis may be portable document format (PDF), document (DOC), document word open XML format (DOCX), or other formats. At block S402, thesis parsing and processing: performing block division processing on the academic thesis to obtain a plurality of block texts, and determining block text data. At block S403, multi-path retrieval and evidence selection: performing keyword retrieval and vector retrieval, determining a fusion score of each block text, and selecting target block texts from the plurality of block texts based on the fusion scores of the plurality of the block texts. At block S404, abstract and key point extraction: performing code element extraction processing, and determining a code element matrix based on the code element and the element content of the code element. At block S405, code generation and interface contract: extracting code constraint information (interface contract) from the code element matrix, using the code constraint information as the prompt text, and obtaining target codes by performing code generation processing based on the code element matrix. At block S406, automated test and execution: generating test codes and performing test processing on the target codes based on the test codes. At block S407, error backtracking and repair: in a case that there is an abnormal code segment in the target codes, performing adjustment processing on the target codes based on a reference source of a target code element related to the abnormal code segment until there is no abnormal code segment in adjusted target codes. At block S408, outputting: repaired codes, a test case, and a verification report.

With the disclosure, (1) an algorithm key point, a mathematical formula, and a verification step in the thesis may be strictly converted into executable codes and perform automated test. Such process not only saves a lot of manual reproduction time but also ensures that the codes are consistent with the algorithm in the thesis, which reduces a possible error during manual reproduction and an error and deviation of manual debugging. (2) The generated codes have a clear evidence source corresponding to each part in the thesis, which makes a reproduction process more transparent and verifiable. (3) By an automated error backtracking and repair mechanism, a closed loop of test-failure-evidence backtracking-minimal repair may be achieved, and the complexity of manual debugging is avoided.

To realize the above embodiments, the disclosure also provides an apparatus for generating codes based on AI. As illustrated in FIG. 5, FIG. 5 is a block diagram according to a fifth embodiment of the disclosure. The apparatus 50 for generating codes based on AI may include: an obtaining module 501, a selecting module 502, and a generating module 503.

The obtaining module 501 is configured to obtain block text data of a multimedia text and a problem text to be processed, in which the block text data includes a plurality of block texts and block information of each block text, and the block information includes formula information; the selecting module 502 is configured to select target block texts from the plurality of block texts based on the plurality of block texts, the formula information in each block information and the problem text; and the generating module 503 is configured to perform code generation processing based on the target block texts, block information of the target block texts and the problem text.

As a possible implementation of embodiments of the disclosure, the obtaining module 501 is specifically configured to obtain the multimedia text; obtain the plurality of block texts by performing block division processing on the multimedia text; for each block text, obtain auxiliary element information by performing auxiliary element extraction processing on the block text, in which an auxiliary element includes one or more formulas and at least one of: an image or a table; for each block text, determine block information of the block text based on the auxiliary element information; and determine the block text data based on the plurality of block texts and the block information of respective block texts.

As a possible implementation of embodiments of the disclosure, the obtaining module 501 is specifically configured to obtain the auxiliary element and/or an auxiliary element sequence number in the block text by performing the auxiliary element extraction processing and auxiliary element sequence number extraction processing on the block text; determine an auxiliary element bound to the auxiliary element sequence number; and determine the auxiliary element information based on the auxiliary element in the block text and/or the auxiliary element bound to the auxiliary element sequence number.

As a possible implementation of the embodiments of the disclosure, the auxiliary element includes the one or more formulas, and the auxiliary element sequence number includes a formula sequence number. The obtaining module 501 is specifically configured to obtain a processed formula by performing aggregation processing on the one or more formulas in the block text based on the formula sequence number; and determine formula information in the auxiliary element information based on the processed formula and/or a formula bound to the formula sequence number.

As a possible implementation of embodiments of the disclosure, the auxiliary element includes the image and/or the table, and the auxiliary element sequence number includes an image sequence number and/or a table sequence number. The obtaining module 501 is specifically configured to determine image information in the auxiliary element information based on a description text of the image in the block text and/or a description text of an image bound to the image sequence number; and/or, determine table information in the auxiliary element information based on a description text of the table in the block text and/or a description text of a table bound to the table sequence number.

As a possible implementation of embodiments of the disclosure, the apparatus also includes: an extracting module, configured to extract range-related information from the problem text; a first determining module, configured to determine a first block text that matches the range-related information in the block text data based on the range-related information; and a first processing module, configured to screening out other block texts in the block text data than the first block text.

As a possible implementation of embodiments of the disclosure, the selecting module 502 is specifically configured to: for each block text, in a case that the block information of the block text includes the formula information, determine a formula matching score of the block text, and at least one of: a keyword matching score or a vector similarity score based on the block text, the block information of the block text and the problem text; determine a fusion score of the block text based on the formula matching score and the at least one of the keyword matching score or the vector similarity score; and select the target block texts from the plurality of block texts based on fusion scores of the plurality of block texts.

As a possible implementation of embodiments of the disclosure, the selecting module 502 is specifically configured to: obtain first keywords in the problem text by performing keyword extraction processing on the problem text; determine second keywords in the first keywords, in which the second keyword is a keyword included in the block text and/or the block information of the block text; and determine the keyword matching score based on a number of second keywords and a number of first keywords.

As a possible implementation of embodiments of the disclosure, the selecting module 502 is specifically configured to: determine a first vector of the block text and a second vector of the problem text; determine a vector similarity between the first vector and the second vector; and determine the vector similarity as the vector similarity score.

As a possible implementation of embodiments of the disclosure, the selecting module 502 is specifically configured to: determine formula information of the problem text; determine at least one of: a formula sequence number matching score, a formula structure matching score or a formula variable matching score based on the formula information of the block text and the formula information of the problem text; and determine the formula matching score based on the at least one of the formula sequence number matching score, the formula structure matching score or the formula variable matching score.

As a possible implementation of the embodiments of the disclosure, the selecting module 502 is specifically configured to: select a plurality of candidate block texts from the plurality of block texts based on the fusion scores of the plurality of block texts; obtain a candidate block text combination by combining at least one candidate block text in the plurality of candidate block texts; determine whether the candidate block text combination satisfies a restricted condition based on a fusion score, a block text weight and a length weight of each candidate block text in the candidate block text combination; in a case that the candidate block text combination satisfies the restricted condition, determine the candidate block text in the candidate block text combination as the target block text; and in a case that the candidate block text combination does not satisfy the restricted condition, re-obtain a candidate block text combination until an obtained candidate block text combination satisfies the restricted condition.

As a possible implementation of embodiments of the disclosure, the generating module 503 is specifically configured to: obtain at least one code element and element content of the at least one code element by performing code element extraction processing on the target block texts and the block information of the target block texts; determine a code element matrix and a reference source of the code element in the code element matrix based on the at least one code element and the element content of the at least one code element, in which the reference source is the target block texts or the block information of the target block texts; extract code constraint information from the code element matrix; and obtain target codes by performing the code generation processing based on the code element matrix using the code constraint information as a prompt text.

As a possible implementation of embodiments of the disclosure, the generating module 503 is specifically configured to: obtain abstract content corresponding to each target block text by performing abstract extraction processing on the target block text and the block information of the target block text; obtain summarized abstract content by performing summarization processing on abstract contents corresponding to respective target block texts; and obtain the at least one code element and the element content of the at least one code element by performing the code element extraction processing on the summarized abstract content.

As a possible implementation of embodiments of the disclosure, the apparatus also includes: a second determining module, configured to determine whether there is a missing code element not configured with element content in the code element matrix; a third determining module, configured to determine a reference knowledge text corresponding to the problem text in a case that there is the missing code element in the code element matrix; a second processing module, configured to perform extraction processing on element content of the missing code element based on the reference knowledge text; and a third processing module, configured to perform update processing on the code element matrix based on the element content of the missing code element.

As a possible implementation of embodiments of the disclosure, the apparatus also includes: the generating module 503, further configured to generate test codes corresponding to the target codes based on the target codes; a testing module, configured to obtain a test result by performing test processing on the target codes based on the test code; a fourth determining module, configured to determine a target code element in the code element matrix related to an abnormal code segment in a case that the test result indicates existence of the abnormal code segment in the target codes; and an adjusting module, configured to perform adjustment processing on the target codes based on a reference source of the target code element, until there is no abnormal code segment in adjusted target codes.

As a possible implementation of embodiments of the disclosure, the adjusting module is specifically configured to: determine a first target block text or first block information related to the abnormal code segment based on the reference source of the target code element; determine an adjustment strategy of the abnormal code segment based on the first target block text or the first block information; and obtain adjusted target codes by performing the adjustment processing on the abnormal code segment in the target codes based on the adjustment strategy.

With the apparatus for generating codes based on AI in the embodiments of the disclosure, the block text data of the multimedia text and the problem text to be processed are obtained, in which the block text data includes the plurality of block texts and the block information of the plurality of block texts, and the at least one piece of the block information includes the formula information; the target block texts are selected from the plurality of block texts based on the plurality of block texts, the formula information in the block information and the problem text; and the code generation processing is performed based on the target block texts, the block information of the target block texts and the problem text. A formula is an important manifestation of a mathematical logic of an algorithm. Selecting the target block texts from the plurality of block texts in combination with the formula information may ensure that the code generation strictly follows a mathematical logic in the multimedia text, which improves the accuracy and logical consistency of the code generation.

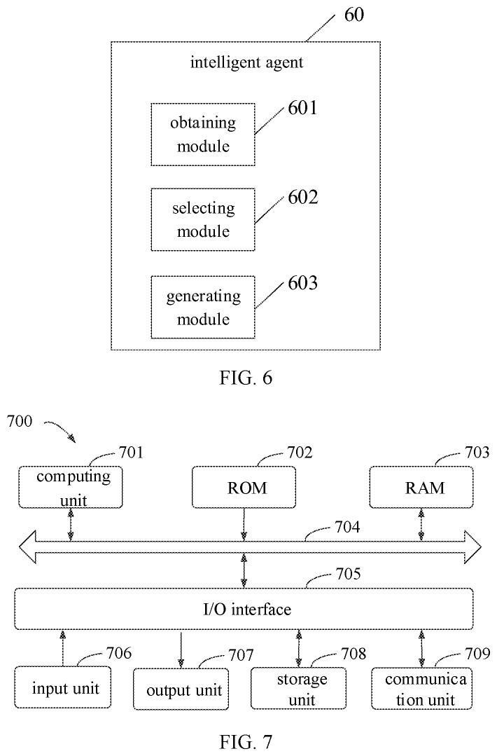

To implement the above embodiments, the disclosure also provides an intelligent agent. As illustrated in FIG. 6, FIG. 6 is a block diagram according to a sixth embodiment of the disclosure.

As illustrated in FIG. 6, an intelligent agent 60 may include: an obtaining module 601, a selecting module 602, and a generating module 603.

The obtaining module 601 is configured to obtain block text data of a multimedia text and a problem text to be processed, in which the block text data includes a plurality of block texts and block information of each block text, and the block information includes formula information; the selecting module 602 is configured to select target block texts from the plurality of block texts based on the plurality of block texts, the formula information in each block information and the problem text; and the generating module 603 is configured to perform code generation processing based on the target block texts, block information of the target block texts and the problem text.

With the intelligent agent in embodiments of the disclosure, the block text data of the multimedia text and the problem text to be processed are obtained, in which the block text data includes the plurality of block texts and the block information of each block text, and the block information includes the formula information; the target block texts are selected from the plurality of block texts based on the plurality of block texts, the formula information in the block information and the problem text; and the code generation processing is performed based on the target block texts, the block information of the target block texts and the problem text. A formula is an important manifestation of a mathematical logic of an algorithm. Selecting the target block texts from the plurality of block texts in combination with the formula information may ensure that code generation strictly follows a mathematical logic in the multimedia text, which improves the accuracy and logical consistency of the code generation.

With the technical solution of the disclosure, processing including collection, storage, use, shaping, transmission, provision and disclosure of the user's personal information is in compliance with the provisions of relevant laws and regulations, and do not violate public order and moral.

According to embodiments of the disclosure, the disclosure also provides an electronic device, a readable storage medium, and a computer program product.

FIG. 7 is a block diagram illustrating an example electronic device 700 for implementing embodiments of the disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components illustrated herein, their connections and relations, and their functions are merely examples, which are not intended to limit the implementations of the disclosure described and/or required herein.

As illustrated in FIG. 7, the device 700 includes a computing unit 701, configured to execute various appropriate actions and processes based on a computer program stored in a read-only memory (ROM) 702 or a computer program loaded from a storage unit 708 to a random access memory (RAM) 703. The RAM 703 may store various programs and data required for an operation of the device 700. The computing unit 701, the ROM 702 and the RAM 703 may be connected with each other via buses 704. An input/output (I/O) interface 705 is also connected to the bus 704.

The multiple components in the device 700 are connected to the I/O interface 705, which include: an input unit 706, such as, a keyboard, a mouse, etc.; an output unit 707, such as, various types of displays, speakers, etc.; a storage unit 708, such as, a magnetic disk, an optical disk, etc.; and a communication unit 709, such as, a network card, a modem, a wireless transceiver, etc. The communication unit 709 allows the device 700 to exchange information/data via a computer network such as Internet and/or various types of telecommunication networks with other devices.

The computing unit 701 may be various types of general and/or dedicated processing components with processing and computing abilities. Some examples of the computing unit 701 include but not limited to a central processing unit (CPU), a graphics processing unit (GPU), various dedicated AI computing chips, various computing units on which a machine learning model algorithm runs, a digital signal processor (DSP), and any appropriate processor, controller, microcontroller, etc. The computing unit 701 executes various methods and processes as described above, for example, a method for generating codes based on AI. For example, in some embodiments, the method for generating codes based on AI may be realized as a computer software program, which is tangibly included in a machine readable medium, such as the storage unit 708. In some embodiments, some or all of the computer program may be loaded and/or installed on the device 700 via the ROM 702 and/or the communication unit 709. When the computer program is loaded on the RAM 703 and executed by the computing unit 701, one or more steps in the method for generating codes based on AI may be executed as described above. Alternatively, in other embodiments, the computing unit 701 may be configured to realize the method for generating codes based on AI in other appropriate ways (for example, by means of a firmware).

Various implementations of the systems and techniques described above may be realized by one and/or a combination of a digital electronic circuit system, an integrated circuit system, a field-programmable gate array (FPGA), an application specific integrated circuit (ASIC), an application specific standard product (ASSP), a system on chip (SoC), a complex programmable logic device (CPLD), computer hardware, firmware, and software. These various embodiments may be realized in one or more computer programs, in which the one or more computer programs may be executed and/or interpreted on a programmable system including at least one programmable processor. The programmable processor may be a dedicated or general programmable processor for receiving data and instructions from a storage system, at least one input device and at least one output device, and transmitting the data and the instructions to the storage system, the at least one input device and the at least one output device.

The program codes configured to realize the method of the disclosure may be written in any combination of one or more programming languages. These program codes may be provided for processors or controllers of general-purpose computers, dedicated computers, or other programmable data processing devices, such that the program codes, when executed by the processors or the controllers, enable the functions/operations specified in the flowcharts and/or the block diagrams to be performed. The program codes may be entirely executed on a machine, partly executed on a machine, partly executed on a machine and partly executed on a remote machine as an independent software package, or entirely executed on a remote machine or server.

In the context of the disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMS, ROMs, electrically programmable read-only memories (EPROMs), fiber optics, compact disc read-only memories (CD-ROMs), optical storage devices, magnetic storage devices, or any suitable combination of the above.

In order to provide interaction with a user, the systems and techniques described herein may be realized on a computer having a display device (e.g., a cathode ray tube (CRT) or a liquid crystal display (LCD) monitor) for displaying information to a user; and a keyboard and a pointing device (such as a mouse or trackball) via which the user may provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or haptic input).

The systems and technologies described herein may be realized in a computing system (e.g., a data server) that includes background components, or a computing system (e.g., an application server) that includes middleware components, or a computing system (e.g., a user computer with a graphical user interface or a web browser, via which the user may interact with the implementations of the systems and technologies described herein) that includes front-end components, or may include any combination of the background components, the middleware components, and the front-end components. The components of the system may be interconnected by any form or medium of digital data communication (e.g., a communication network). Examples of the communication network include: a local area network (LAN), a wide area network (WAN), and the Internet.

The computer system may include a client and a server. The client and server are generally remote from each other and interacting via a communication network. A relationship between the client and the server is generated by computer programs running on corresponding computers and having a client-server relation with each other. The server may be a cloud server, a server of a distributed system, or a server combined with a block-chain.

It may be understood that various forms of processes illustrated above may be used to reorder, add or delete steps. For example, the steps described in the disclosure could be performed in parallel, sequentially, or in different orders, as long as the desired result of the technical solution disclosed in the disclosure is achieved, which is not limited herein.

The above detailed embodiments do not constitute a limitation on the protection scope of the disclosure. Those skilled in the art should understand that various modifications, combinations, sub-combinations and substitutions may be made according to design requirements and other factors. Any modification, equivalent replacement and improvement made within the spirit and principle of the disclosure shall be included in the protection scope of the disclosure.

1. A method for generating codes based on artificial intelligence (AI), comprising:
obtaining block text data of a multimedia text and a problem text to be processed, wherein the block text data comprises a plurality of block texts and block information of each block text, and the block information comprises formula information;
selecting target block texts from the plurality of block texts based on the plurality of block texts, the formula information in each block information and the problem text; and
performing code generation processing based on the target block texts, block information of the target block texts and the problem text.

2. The method of claim 1, wherein obtaining the block text data of the multimedia text comprises:
obtaining the multimedia text;
obtaining the plurality of block texts by performing block division processing on the multimedia text;
for each block text, obtaining auxiliary element information by performing auxiliary element extraction processing on the block text, wherein an auxiliary element comprises one or more formulas and at least one of: an image or a table;
for each block text, determining block information of the block text based on the information of the auxiliary element; and
determining the block text data based on the plurality of block texts and block information of respective block texts.

3. The method of claim 2, wherein obtaining the auxiliary element information by performing the auxiliary element extraction processing on the block text comprises:
obtaining the auxiliary element and/or an auxiliary element sequence number in the block text by performing the auxiliary element extraction processing and auxiliary element sequence number extraction processing on the block text;
determining an auxiliary element bound to the auxiliary element sequence number; and
determining the auxiliary element information based on at least one of the auxiliary element in the block text or the auxiliary element bound to the auxiliary element sequence number.

4. The method of claim 3, wherein the auxiliary element comprises the one or more formulas, the auxiliary element sequence number comprises a formula sequence number, and determining the auxiliary element information based on the at least one of the auxiliary element in the block text or the auxiliary element bound to the auxiliary element sequence number comprises:
obtaining a processed formula by performing aggregation processing on the one or more formulas in the block text based on the formula sequence number; and
determining formula information in the auxiliary element information based on at least one of the processed formula or a formula bound to the formula sequence number.

5. The method of claim 3, wherein the auxiliary element comprises at least one of the image or the table, the auxiliary element sequence number comprises at least one of an image sequence number or a table sequence number, and determining the auxiliary element information based on at least one of the auxiliary element in the block text or the auxiliary element bound to the auxiliary element sequence number comprises:
determining image information in the auxiliary element information based on at least one of a description text of the image in the block text or a description text of an image bound to the image sequence number;
and/or,
determining table information in the auxiliary element information based on a description text of the table in the block text and/or a description text of a table bound to the table sequence number.

6. The method of claim 1, before selecting the target block texts from the plurality of block texts based on the plurality of block texts, the block information of each block texts and the problem text, further comprising:
extracting range-related information from the problem text;
determining, based on the range-related information, a first block text matching the range-related information in the block text data; and
screening out other block texts in the block text data than the first block text.

7. The method of claim 1, wherein selecting the target block texts from the plurality of block texts based on the plurality of block texts, the formula information in each block information and the problem text comprises:
for each block text, in a case that the block information of the block text comprises the formula information, determining a formula matching score of the block text and at least one of: a keyword matching score or a vector similarity score based on the block text, the block information of the block text and the problem text;
determining a fusion score of the block text based on the formula matching score and the at least one of the keyword matching score or the vector similarity score; and
selecting the target block texts from the plurality of block texts based on fusion scores of the plurality of block texts.

8. The method of claim 7, wherein determining the keyword matching score of the block text comprises:
obtaining first keywords in the problem text by performing keyword extraction processing on the problem text;
determining second keywords in the first keywords, wherein the second keyword is a keyword comprised in at least one of the block text or the block information of the block text; and
determining the keyword matching score based on a number of second keywords and a number of first keywords.

9. The method of claim 7, wherein determining the vector similarity score of the block text comprises:
determining a first vector of the block text and a second vector of the problem text;
determining a vector similarity between the first vector and the second vector; and
determining the vector similarity as the vector similarity score.

10. The method of claim 7, wherein determining the formula matching score of the block text comprises:
determining formula information of the problem text;
determining at least one of: a formula sequence number matching score, a formula structure matching score or a formula variable matching score based on the formula information of the block text and the formula information of the problem text; and
determining the formula matching score based on the at least one of the formula sequence number matching score, the formula structure matching score or the formula variable matching score.

11. The method of claim 7, wherein selecting the target block texts from the plurality of block texts based on the fusion scores of the plurality of block texts comprises:
selecting a plurality of candidate block texts from the plurality of block texts based on the fusion scores of the plurality of block texts;
obtaining a candidate block text combination by combining at least one candidate block text in the plurality of candidate block texts;
determining whether the candidate block text combination satisfies a restricted condition based on a fusion score, a block text weight and a length weight of each candidate block text in the candidate block text combination;
in a case that the candidate block text combination satisfies the restricted condition, determining the candidate block text in the candidate block text combination as the target block text; and
in a case that the candidate block text combination does not satisfy the restricted condition, re-obtaining a candidate block text combination until an obtained candidate block text combination satisfies the restricted condition.

12. The method of claim 1, wherein performing the code generation processing based on the target block texts, the block information of the target block texts and the problem text comprises:
obtaining at least one code element and element content of the at least one code element by performing code element extraction processing on the target block texts and the block information of the target block texts;
determining a code element matrix and a reference source of the code element in the code element matrix based on the at least one code element and the element content of the at least one code element, wherein the reference source is the target block texts or the block information of the target block texts;
extracting code constraint information from the code element matrix; and
obtaining target codes by performing the code generation processing based on the code element matrix using the code constraint information as a prompt text.

13. The method of claim 12, wherein obtaining the at least one code element and the element content of the at least one code element by performing the code element extraction processing on the target block texts and the block information of the target block texts comprises:
obtaining abstract content corresponding to each target block text by performing abstract extraction processing on the target block text and the block information of the target block text;
obtaining summarized abstract content by performing summarization processing on abstract contents corresponding to respective target block texts; and
obtaining the at least one code element and the element content of the at least one code element by performing the code element extraction processing on the summarized abstract content.

14. The method of claim 12, before extracting the code constraint information from the code element matrix, further comprising:
determining whether there is a missing code element not configured with element content in the code element matrix;
in a case that there is the missing code element in the code element matrix, determining a reference knowledge text corresponding to the problem text;
performing extraction processing on element content of the missing code element based on the reference knowledge text; and
performing update processing on the code element matrix based on the element content of the missing code element.

15. The method of claim 12, further comprising:
generating test codes corresponding to the target codes based on the target codes;
obtaining a test result by performing test processing on the target codes based on the test code;
in a case that the test result indicates existence of an abnormal code segment in the target codes, determining a target code element in the code element matrix related to the abnormal code segment; and
performing adjustment processing on the target codes based on a reference source of the target code element, until there is no abnormal code segment in adjusted target codes.

16. The method of claim 15, wherein performing the adjustment processing on the target codes based on the reference source of the target code element comprises:
determining a first target block text or first block information related to the abnormal code segment based on the reference source of the target code element;
determining an adjustment strategy of the abnormal code segment based on the first target block text or the first block information; and
obtaining adjusted target codes by performing the adjustment processing on the abnormal code segment in the target codes based on the adjustment strategy.

17. An electronic device, comprising:
at least one processor; and
a memory communicatively coupled to the at least one processor, wherein
the memory stores instructions executable by the at least one processor that, when executed by the at least one processor, the at least one processor is caused to execute:
obtaining block text data of a multimedia text and a problem text to be processed, wherein the block text data comprises a plurality of block texts and block information of each block text, and the block information comprises formula information;
selecting target block texts from the plurality of block texts based on the plurality of block texts, the formula information in each block information and the problem text; and
performing code generation processing based on the target block texts, block information of the target block texts and the problem text.

18. A non-transitory computer-readable storage medium for storing computer instructions, wherein the computer instructions are configured to enable a computer to execute:
obtaining block text data of a multimedia text and a problem text to be processed, wherein the block text data comprises a plurality of block texts and block information of each block text, and the block information comprises formula information;
selecting target block texts from the plurality of block texts based on the plurality of block texts, the formula information in each block information and the problem text; and
performing code generation processing based on the target block texts, block information of the target block texts and the problem text.

19. The electronic device of claim 17, wherein the at least one processor is configured to execute: obtaining the multimedia text;
obtaining the plurality of block texts by performing block division processing on the multimedia text;
for each block text, obtaining auxiliary element information by performing auxiliary element extraction processing on the block text, wherein an auxiliary element comprises one or more formulas and at least one of: an image or a table;
for each block text, determining block information of the block text based on the information of the auxiliary element; and
determining the block text data based on the plurality of block texts and block information of respective block texts.

20. The electronic device of claim 19, wherein the at least one processor is configured to execute:
obtaining the auxiliary element and/or an auxiliary element sequence number in the block text by performing the auxiliary element extraction processing and auxiliary element sequence number extraction processing on the block text;
determining an auxiliary element bound to the auxiliary element sequence number; and
determining the auxiliary element information based on at least one of the auxiliary element in the block text or the auxiliary element bound to the auxiliary element sequence number.
